(19) United States
(12) Patent Application Publication
(10) Pub. No.: US 2016/0069070 A1
(43) Pub. Date: Mar. 10, 2016

(54) TWO-LAYER GLASS FIBER MAT COMPOSITE

(71) Applicant: United States Gypsum Company, Chicago, IL (US)

(72) Inventor: Alfred Li, Naperville, IL (US)

(21) Appl. No.: 14/482,541

(22) Filed: Sep. 10, 2014

(51) Int. Cl. E04B 2/02; B32B 37/10; B32B 37/12; B32B 37/20; B32B 5/18; B32B 13/14

(52) U.S. Cl. CPC E04B 2/02; B32B 5/18; B32B 13/14; B32B 37/1207; B32B 37/20; B32B 37/1018; B32B 2260/021; B32B 2260/046; B32B 2262/101; B32B 2607/00; B32B 2419/00; B32B 2305/20; B32B 2307/542; B32B 2307/72; B32B 2310/028; B32B 2323/10; B32B 2323/046; B32B 2367/00; B32B 2355/00; B32B 2375/00; B32B 2333/08; E04B 2002/0286

(57) ABSTRACT

A gypsum product comprising a gypsum core and a two-layer polar glass fiber mat with smooth finish is provided. The two-layer polar glass fiber mat covers the gypsum core on at least one side and has a face surface and a back surface. The two-layer polar glass fiber mat comprises a glass fiber mat and a top porous layer, the top porous layer is adhered to the glass fiber mat on one side and creates the face surface, and the gypsum core is in contact with the glass fiber mat on the back surface of the two-layer polar glass fiber mat. Methods for making the gypsum product are provided as well. Further embodiments provide a two-layer polar glass fiber mat with a hydrophilic face surface and methods of making same.

### CROSS-REFERENCE TO RELATED APPLICATIONS

This patent application relates to U.S. patent application Ser. No. 14/451,817 and U.S. patent application Ser. No. 14/467,257, the entire disclosures of which are incorporated herein by reference.

### FIELD OF THE INVENTION

This invention provides gypsum products with glass fiber mats and improved smooth surface finish such that the products are suitable for various interior applications. Methods for obtaining the products are provided as well.

### BACKGROUND

Various gypsum products, including wall panels, ceiling panels and tiles, are commonly used in the construction industry. Many of these gypsum products are made by preparing an aqueous gypsum slurry with calcined gypsum (calcium sulfate alpha hemihydrate, calcium sulfate beta hemihydrate and/or calcium sulfate anhydrate), shaping the slurry and then allowing the slurry to harden by rehydrating calcined gypsum into gypsum (calcium sulfate dihydrate).

Gypsum panels can be manufactured by sandwiching a gypsum slurry between two cover sheets known as facers. In some applications, a facer is a paper sheet. Such wallboards in which a gypsum slurry is sandwiched between two sheets of paper find many different applications in building construction. However, wallboards may be sensitive to moisture and at least in some applications, other facer materials such as fibrous mats can be used as described for example in U.S. Pat. No. 8,329,308 and US Patent Publication 2010/0143682, both to the United States Gypsum Company, and the teachings of which are incorporated herein by reference. Suitable fibrous mats further include those disclosed in U.S. Pat. No. 5,772,846 and which are made with glass fibers and polyester fibers bound together.

US Patent Publication 2011/0086214 laminates one of the glass mat surfaces with a stiffening layer before the mat can be used in making a gypsum product. US Patent Publication 2002/0187296 discloses an assembly line on which a glass fiber mat is vibrated so that voids in the mat are more evenly filled with a gypsum slurry. U.S. Pat. No. 4,948,647 discloses gypsum products with a laminated composite facing of an outer nonwoven fiber mat and an inner woven fiber scrim bound together by an acrylic film. U.S. Pat. No. 6,524,679 discloses gypsum boards with face sheets comprising glass fibers and a combination of set gypsum and polymeric compound. Finally, U.S. Pat. No. 5,837,621 discloses glass fiber mats coated with at least one nitrogen containing compound.

While gypsum panels made with glass fiber mats have many advantages, one of the disadvantages is the resulting boards may have a relatively rough surface. As shown in micrographs of FIGS. 1A-1B, with FIG. 1B being a micrograph with a larger magnification, the surface finish of a typical fiber glass mat made with 1 inch glass fibers can be characterized as rough. When this glass fiber mat is used for making gypsum boards, wrinkles develop during the curing stage and the local variations in the form of hills and valleys on the fiber glass mat can be easily seen on the board surface shown in FIGS. 1C and 1D, with 1D being a micrograph taken under a larger magnification. However, it is desirable, especially in connection with interior designs, to obtain gypsum boards with smooth surface.

### SUMMARY OF THE INVENTION

This invention provides wallboards and other gypsum products made with glass fiber mats such that the resulting gypsum product has a smooth finish, improved uniformed density and strength.

One embodiment provides a gypsum product comprising a gypsum core and at least one two-layer polar glass fiber mat which covers the gypsum core on at least one side. The two-layer polar glass fiber mat has a face surface and a back surface and comprises a glass fiber mat and a top porous layer, the top porous layer is adhered to the glass fiber mat on one side and creates the face surface, and the gypsum core is in contact with the glass fiber mat on the back surface of the two-layer polar glass fiber mat. Glass fibers in the glass fiber mat may be cross-linked with gypsum and compressed. In further embodiments, glass fibers in the glass fiber mat are cross-linked with a thermosetting polymeric resin such as a polyacrylate, polystyrene, polyester, polyethylene, polypropylene, polybutylene and any mixture thereof. At least some the contemplated gypsum products have a level 4 or 5 finish.

Various synthetic materials can be used for the top porous layer, including a synthetic membrane, polymeric film and synthetic paper. In some embodiments, the top porous layer can be made from at least one of the following: polytetrafluoroethylene, polypropylene fibers, LDPE (low-density polyethylene) fibers, acrylic fibers, polyester fibers, polyester/nylon fibers, urethane films, plastic films, polyurethane films and plastic netting.

The top porous layer is adhered to the glass fiber mat by a thermosetting polymeric resin such as for example, a polyacrylate, polystyrene, polyester, polyethylene, polypropylene, polybutylene, phenol-formaldehyde, urea-formaldehyde, melamine-formaldehyde and any mixture thereof.

Some embodiments provide a gypsum product in which the porosity of the glass fiber mat is different from the porosity of the top porous layer, with the porosity of the top porous layer being in the range from 20 to 80 sec/100 cc.

Further embodiments provide methods for making a gypsum product comprising a gypsum core which is sandwiched between at least one two-layer polar glass fiber mat. In these methods, a glass fiber mat is obtained and laminated with a thermosetting polymeric resin. The mat is then covered on one side with a porous synthetic material such as synthetic paper, synthetic film or synthetic membrane. The synthetic material is adhered to the glass fiber mat with a thermosetting resin such as a polyacrylate, polystyrene, polyester, polyethylene, polypropylene, polybutylene, phenol-formaldehyde, urea-formaldehyde or melamine-formaldehyde. The thermosetting resin is then allowed to cure and this results in a two-layer polar glass fiber mat with a smooth face surface created by the synthetic porous material. A gypsum slurry which comprise calcined gypsum and water is prepared and deposited on the back surface of the two-layer polar glass fiber mat, and the gypsum product is allowed to set. Further methods include those in which penetration of a gypsum slurry into glass fibers of the two-layer glass fiber mat is achieved by at least one of the following: by applying vacuum to the face surface of the cured two-layer polar glass fiber mat after the gypsum slurry is deposited onto the back surface of the cured two-layer polar glass fiber mat; by causing the cured two-layer polar glass fiber mat to vibrate prior to, concurrently with or subsequently after the gypsum slurry is deposited onto the back surface of the cured two-layer glass fiber mat; and by applying ultrasonic sound to the cured two-layer polar glass fiber mat prior to, concurrently with or subsequently after the gypsum slurry is deposited onto the back surface of the cured two-layer glass fiber mat.

Further embodiments provide a two-layer polar glass fiber mat which comprises a glass fiber mat covered on at least one side with a porous synthetic layer which is adhered to glass fiber of the glass fiber mat. The porous synthetic layer may be made from at least one of the following: polytetrafluoroethylene, polypropylene fibers, LDPE (low-density polyethylene) fibers, acrylic fibers, polyester fibers, polyester/nylon fibers, urethane films, plastic films, polyurethane films and plastic netting. The porous synthetic layer may be adhered to the glass fiber mat with a thermosetting polymeric resin selected from polyacrylate, polystyrene, polyester, polyethylene, polypropylene, polybutylene, phenol-formaldehyde, urea-formaldehyde, melamine-formaldehyde and any mixture thereof. At least in some embodiments, the porous synthetic layer is hydrophilic. Further embodiments include two-layer polar glass fiber mats in which the porosity of the glass fiber mat is different from the porosity of the porous synthetic layer, and wherein the porosity of the porous synthetic layer is in the range from 20 to 80 sec/100 cc.

### BRIEF DESCRIPTION OF THE DRAWINGS

FIGS. 1A-1D are micrographs for a glass fiber mat (FIGS. 1A and 1B, where 1B is a larger magnification) and a gypsum board made with the glass fiber mat (FIGS. 1C and 1D, where 1D is a larger magnification).

FIG. 2 is a schematic for a process in which a glass fiber mat is treated with a thermosetting polymeric resin.

FIG. 3 is a schematic of a two-layer glass fiber mat composite.

FIG. 4 is a schematic of a process for obtaining a two-layer glass fiber mat.

FIG. 5 is a schematic of an alternative process for obtaining a two-layer glass fiber mat.

FIG. 6 is a schematic of a process for obtaining a gypsum product with a two-layer glass fiber mat.

### DETAILED DESCRIPTION

The present invention provides gypsum products, including a gypsum wallboard, with improved smooth finish. Methods for obtaining such products are provided as well. At least some embodiments provide gypsum wallboards made with a two-layer glass fiber mat and which meet the requirements for a level 5 finish, the highest quality finish defined by the Gypsum Association in “Recommended levels of gypsum board finish.” Further embodiments provide gypsum products made with a two-layer glass fiber mat and suitable for various interior designs. One of the products is a gypsum wallboard, other products may include without any limitation, tiles, panels, partitions and the like. Further embodiments include a two-layer glass fiber mat which can be used in a variety of cementitious and gypsum products where a smooth finish, moisture-resistance and durability are desired. Such products include furniture, countertop covers, water-proof parts, windows, doors, sidings and the like.

A gypsum wallboard can be obtained by preparing a slurry comprising gypsum and then depositing the gypsum slurry onto a glass fiber mat. A second glass fiber mat can be used as a cover sheet. In alternative embodiments, paper can be used as the second cover sheet. In yet further embodiments, the gypsum slurry can be deposited onto a wire frame and covered with a glass fiber sheet. A person of skill will further appreciate various other modifications in which a gypsum product is produced from a slurry comprising gypsum and at least one glass fiber mat.

Various glass fiber mats without limitations are suitable for making these gypsum products, including mats made with chopped glass fibers, continuous strand glass fibers, mats with random orientation of glass fibers and mixtures therefore.

At least in some embodiments, a glass fiber mat can be prepared from glass fibers which are bound together with at least one binder. Suitable binders include, but are not limited to, a styrene acrylic binder. At least in some embodiments, a glass fiber mat is formulated from glass fibers and a binder such that glass fibers comprise from about 50% to about 80% by weight of the mat and a binder comprises from about 10 to about 30% by weight of the mat. One suitable glass fiber mat is the DuraGlass® 8924 Mat, manufactured by Johns Manville and made with about 70% of glass fibers and about 30% of an acrylic binder.

At least in some embodiments, a glass fiber mat can be formulated with fibers in a length of between about 0.5 to about 2.0 inches and a diameter of between about 6 and about 25 microns. At least in some embodiments, a glass fiber mat is formulated with biosoluble microfibers which have a diameter of about 3 microns. Biosoluble microfibers may comprise from 10% to 90% of all glass fibers. Some additional embodiments include those in which glass fibers with a preferred length of about 1 inch are used.

A glass fiber mat can optionally further comprise fillers, pigments, or other inert or active ingredients. For example, the mat can comprise at least one of a coloring pigment, biocide, fungicide, or mixtures thereof. Such additives can be useful to after the coloration, modify the structure or texture of the surface, improve resistance to mold or fungus formation, and enhance fire resistance.

Suitable glass fiber mats include those which are laminated with a polymeric resin prior to their use for making gypsum products. Various resins can be used for laminating a glass fiber mat, including those described in U.S. patent application Ser. No. 14/451,817, the disclosure of which is incorporated herein in its entirety.

A glass fiber mat can be laminated with a water-soluble acrylic binder and then cured by thermosetting and/or with a chemical compound, referred to as a “hardener,” which triggers a cross-linking reaction in the acrylic binder. Various thermoplastic polymers are suitable for laminating a glass fiber mat, including polyacrylate, polystyrene, polyester, polyethylene, polypropylene, polybutylene and mixtures thereof. Various curable water-soluble acrylic resins are suitable for this method. Such resins include thermocurable acrylo-polyester resins, including acrylo-polyester binders with hydroxyl functional groups. Acrylo-polyester binders can be prepared as aqueous solutions. Suitable aqueous solutions include solutions with 25 to 75% solids. Suitable aqueous solutions further include solutions with 50% solids. One suitable binder includes a thermosetting acrylo-polyester binder which forms an acrylo-polyester network when blended with hydroxyl-functional groups and exposed to heat, available from HB Fuller under the trade name NF4AD™. Other suitable binders include a system with non formaldehyde, water-soluble modified polyacrylic acid and a polyalcohol crosslinker, available from BASF under the trade name ACRODUR™. Other suitable binders also include a non-formaldehyde, water-soluble, liquid polyalcohol resin binder, available from BASF under the trade name ARCLIN™ 7018.

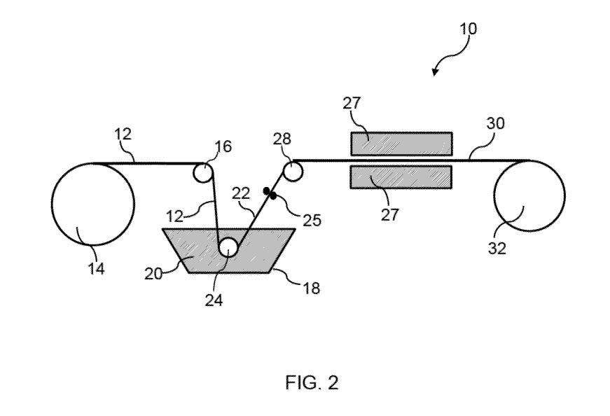

Referring to FIG. 2, a process for laminating a glass fiber mat, generally 10, includes feeding an untreated glass fiber sheet 12 from a reel 14 with a rolling means 16 into a bath 18 filled with a polymeric resin 20 suitable for laminating a glass fiber mat.

After the treatment with the resin 20 in the bath 18, a laminated glass fiber mat 22 is rolled out from the bath 18 with at least one rolling means 24 and metered with a metering element 25. The laminated glass fiber mat 22 is then fed into a dryer 27 with at a rolling means 28. After the resin 20 is cured on the glass fiber mat 22 in the dryer 27, the finished laminated glass fiber mat 30 is then rolled into a reel 32 or it can be cut into sheets of any length. A laminated glass fiber mat obtained by the process of FIG. 2 has many advantages such as it is durable, resistant to moisture, but it has an uneven, rough finish.

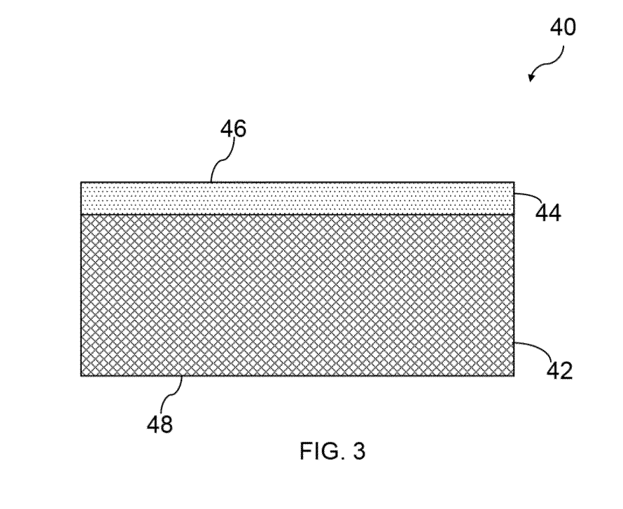

Referring to FIG. 3, one embodiment provides a two-layer glass fiber mat, generally 40. It comprises a glass fiber mat 42 in which glass fibers may be cross-linked with a polymeric resin and a top layer 44 which is adhered and cross-linked to the glass fiber mat 42 with a thermosetting polymeric resin. Suitable polymeric thermosetting resins include a water-soluble acrylic binder which is cured by thermosetting and/or with a chemical compound, referred to as a “hardener,” which triggers a cross-linking reaction in the acrylic binder. Various thermoplastic resins are contemplated, including polyacrylate, polystyrene, polyester, polyethylene, polypropylene, polybutylene and mixtures thereof. Various curable water-soluble acrylic resins are suitable as wed. Such resins include thermocurable acrylo-polyester resins, including acrylo-polyester binders with hydroxyl functional groups. Acrylo-polyester binders can be prepared as aqueous solutions. Suitable aqueous solutions include solutions with 25 to 75% solids. Suitable aqueous solutions further include solutions with 50% solids. One suitable binder includes a thermosetting acrylo-polyester binder which forms an acrylo-polyester network when blended with hydroxyl-functional groups and exposed to heat, available from HB Fuller under the trade name NF4AD™. Other suitable binders include a system with non-formaldehyde, water-soluble modified polyacrylic acid and a polyalcohol crosslinker, available from BASF under the trade name ACRODUR™. Other suitable binders also include a non-formaldehyde, water-soluble, liquid polyalcohol resin binder, available from BASF under the trade name ARCLIN™ 7018. Other thermosetting binders can be used as well, including a phenol-formaldehyde binder available under the trade name RESI-STRAIN/WOODWELD™ from GP, Inc., a urea-formaldehyde binder available under the trade name NOVARES™ from GP. Inc., a melamine formaldehyde binder available under the trade name GP™ urea from GP, Inc., formaldehyde-free resins AQUASET™ 100 and AQUASET™ 600 available from DOW Construction Chemicals, Inc., and PLENCO™ phenolic and NOVOLAC™ resins from Plenco, Inc.

The glass fiber mat 42 can be any glass fiber mat, including those which are produced by saturating a glass fiber mat with a thermosetting polymeric resin. Suitable glass fiber mats include the DuraGlass® 8924 Mat, manufactured by Johns Manville and the like. In some embodiments, the glass fiber mat 42 is not saturated and cross-linked with a polymeric resin, but the top layer 44 is still adhered to the glass fiber mat 42 with a thermosetting polymeric binder which is selected from polymeric thermosetting resins, including a water-soluble acrylic binder which is cured by thermosetting and/or with a chemical compound, referred to as a “hardener,” which triggers a cross-linking reaction in the acrylic binder. Various thermoplastic resins are contemplated, including polyacrylate, polystyrene, polyester, polyethylene, polypropylene, polybutylene and mixtures thereof. Various curable water-soluble acrylic resins are suitable as well. Such resins include thermocurable acrylo-polyester resins, including acrylo-polyester binders with hydroxyl functional groups. Acrylo-polyester binders can be prepared as aqueous solutions. Suitable aqueous solutions include solutions with 25 to 75% solids. Suitable aqueous solutions further include solutions with 50% solids. One suitable binder includes a thermosetting acrylo-polyester binder which forms an acrylo-polyester network when blended with hydroxyl-functional groups and exposed to heat, available from HB Fuller under the trade name NF4AD™. Other suitable binders include a system with non-formaldehyde, water-soluble modified polyacrylic acid and a polyalcohol crosslinker, available from BASF under the trade name ACRODUR™. Other suitable binders also include a non-formaldehyde, water-soluble, liquid polyalcohol resin binder, available from BASF under the trade name ARCLIN™ 7018. Other thermosetting binders can be used as well to adhere the top layer 44 to the glass fiber mat 42, including a phenol-formaldehyde binder available under the trade name RESI-STRAIN/WOODWELD™ from GP, Inc., a urea-formaldehyde binder available under the trade name NOVARES™ from GP, Inc., a melamine formaldehyde binder available under the trade name GP™ urea from GP, Inc., formaldehyde-free resins AQUASET™ 100 and AQUASET™ 600 available from DOW Construction Chemicals, Inc., and PLENCO™ phenolic and NOVOLAC™ resins from Plenco, Inc.

The two-layer glass fiber mat 40 is polar and it has a face surface 46 on the side of the top layer 44 and a back surface 48 on the other side of the glass fiber mat 42. In some embodiments, the thickness of the glass fiber mat 42 is at about 20 to 40 mils. The back surface 48 of the two-layer glass fiber mat 40 is rough with the porosity value being very low. In contrast, the face surface 46 is smooth and it is created by a synthetic material from which the top layer 44 is made. This synthetic material can be a porous membrane, a porous film or synthetic paper.

The top layer 44 can be prepared from various materials. Such materials include, but are not limited to, polymers, inorganic materials and ceramic materials. A suitable synthetic material is chemically, thermally and mechanically stable. It can be also biologically inert. In some embodiments, the synthetic material is further water-resistant.

One synthetic material suitable for preparing the synthetic porous membrane 44 for a two-layer glass fiber mat 40 is polytetrafluoroethylene (PTFE, which is available under the trade names TEFLON™, FLUON™, HOSTAFLON™ and POLYFLON™). Another suitable synthetic material is synthetic paper which can be made of polypropylene fibers, LDPE (low-density polyethylene) fibers, acrylic fibers, polyester fibers, and polyester/Nylon fibers and any mixture thereof. A blend of different fiber types and lengths is also suitable for use in the top layer 44.

Suitable synthetic paper includes synthetic, white opaque, single-layer, microporous printing material that behaves more like paper than plastic and which is available from Teslin, Inc. under the trade name TESLIN™ high-performance synthetic paper. Another suitable synthetic paper includes engineered extruded mineral-filled polypropylene synthetic paper with enhanced rigidity, available under the trade name PRO-PRINT™ PLUS from Transilwarp, Inc. Yet another suitable synthetic paper is flashspun nonwoven HDPE fiber synthetic paper which is available under the trade name DUPONT™ TYVEK from Dupont, Inc. This paper is lightweight and durable. It comprises spunbonded olefin, repels water and resists tearing. It has class A flammability rating and is chemically resistant. Yet another suitable synthetic paper includes synthetic paper available under the trade name YUPO™ original from YUPO, Inc.

In further embodiments, the top layer 44 may be a synthetic film. Suitable synthetic films include urethane films, plastic films, polyurethane films and plastic netting. Such synthetic films include medical breathable urethane film from Medco, Inc, plastic films available under the trade name BFI™-1880 Metallocene Film from Blueridgefilms, Inc., polyurethane film available under the trade name breathable TRU™ film from Stevensurethane, Inc. and plastic netting XN 1678 from Industrialnetting, Inc.

In some embodiments, the face surface 46 of the top layer 44 is hydrophilic. This can be achieved through chemical modification of the face surface 46 such that some degree of water absorption is permitted, which is important for a finishing process during which a coat of paint and/or joint compound is applied to the face surface 46 of the glass fiber mat 40.

In some embodiments, the thickness of the top layer 44 is from about 1 to about 5 mils. The face surface 46 has a smooth finish which is suitable for making gypsum products to achieve a level 4 or 5 finish as defined by the Gypsum Association in “Recommended levels of gypsum board finish.” In some embodiments, the porosity value of the top layer 44 is in the range from 20 to 80 sec/100 cc.

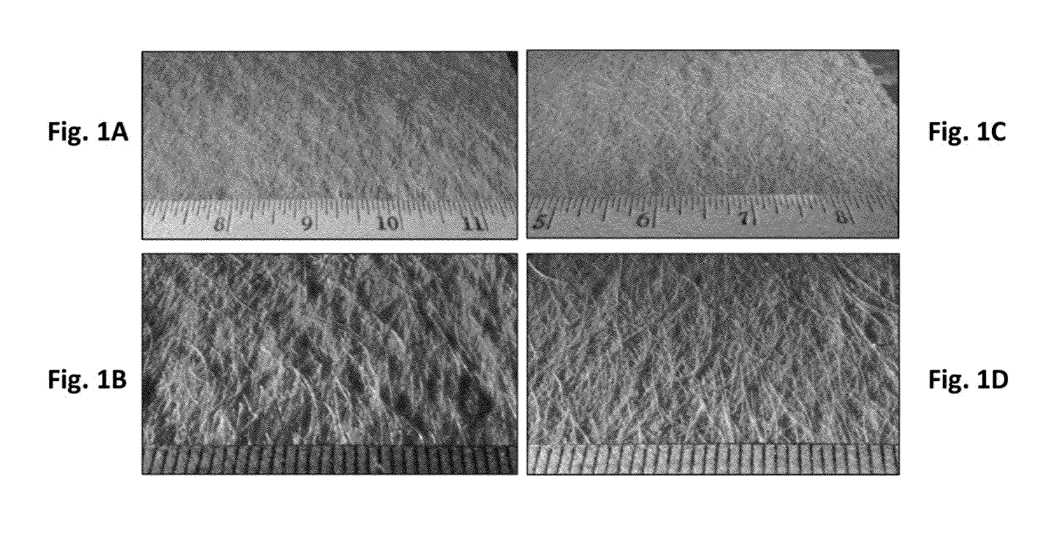

A nail-pull test can be performed in accordance with the American Society for Testing Materials (ASTM) standard C473-00 and utilizes a machine that pulls on a head of a nail inserted in the wallboard to determine the maximum force required to pull the nail head through the wallboard. A glass fiber mat is compressed as the nail head is pushed down through a gypsum product, and the force needed to pull the nail head through the wallboard is recorded. As shown in FIGS. 1A and 1B, a glass fiber mat is made of glass fibers which are very brittle. The nail head easily cuts through the glass fiber mat with little resistance, resulting in low nail-pull load.

The nail-pull strength of a two-layer glass fiber mat 40 is enhanced in comparison to a glass fiber mat without a top porous layer 44. One function of the top layer 44 is to provide some additional resistance against the nail head so as to protect the glass mat fibers from being cut during a nail-pull strength test. The top layer 44 exhibits some degree of elasticity similar to paper made of cellulose fibers.

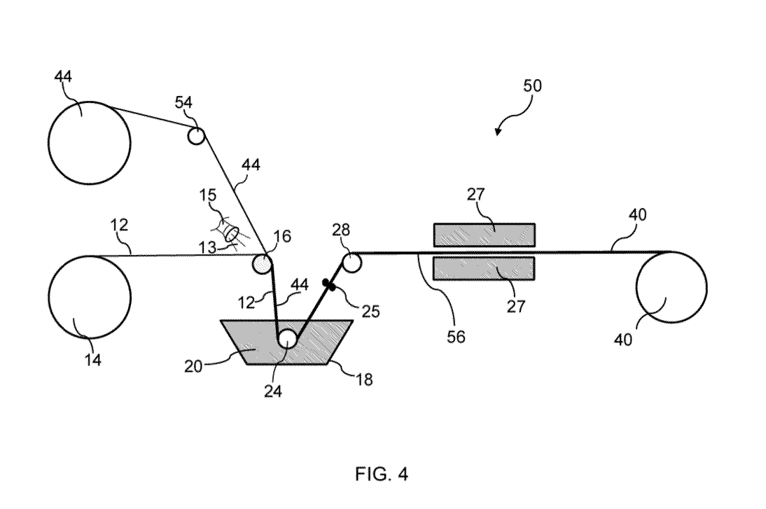

Various methods can be used for obtaining a two-layer glass fiber mat 40. One embodiment provides a method, generally 50, as shown in FIG. 4. In this method, an untreated glass fiber sheet 12 is fed from a reel 14 with a rolling means 16 into a bath 18 filled with a polymeric resin 20 suitable for laminating a glass fiber mat. Various thermoplastic polymers are suitable for laminating a glass fiber mat, including polyacrylate, polystyrene, polyester, polyethylene, polypropylene, polybutylene and mixtures thereof. Various curable water-soluble acrylic resins are suitable for this method. Such resins include thermocurable acrylo-polyester resins, including acrylo-polyester binders with hydroxyl functional groups. Acrylo-polyester binders can be prepared as aqueous solutions. Suitable aqueous solutions include solutions with 25 to 75% solids. Suitable aqueous solutions further include solutions with 50% solids. One suitable binder includes a thermosetting acrylo-polyester binder which forms an acrylo-polyester network when blended with hydroxyl-functional groups and exposed to heat, available from HB Fuller under the trade name NF4AD™. Other suitable binders include a system with non-formaldehyde, water-soluble modified polyacrylic acid and a polyalcohol crosslinker, available from BASF under the trade name ACRODUR™. Other suitable binders also include a non-formaldehyde, water-soluble, liquid polyalcohol resin binder, available from BASF under the trade name ARCLIN™ 7018.

A porous membrane 44 is fed by rolling means 54 such that the porous membrane 44 comes in contact with the glass fiber mat 12 on the face side of the glass fiber mat 12, and the two-layers 12/44 are fed into the bath 18, where the two-layers 12/44 are soaked with the polymeric resin 20. A two-layer glass fiber mat 56 in which the synthetic porous membrane 44 is now adhered to the glass fiber mat 12 by the polymeric resin 20 on the face side is then rolled out from the bath 18 and through a metering element 25. The two-layer glass fiber mat 56 is then fed by a rolling means 28 into a dryer 27 in which the polymeric resin 20 is cured and cross-links glass fibers in the two-layer glass fiber mat 56. The polymeric resin 20 also binds and adheres the porous membrane 44 to the glass fiber mat 56. After thermosetting in the dryer 27, the two-layer glass fiber mat 40 can be rolled for storage into a reel. It will be appreciated from this method that the two-layer glass fiber mat 40 is polar with one surface, the face surface, being smooth and porous because it is created by a porous synthetic top layer 44, and the other surface, the back surface, being rough as it comprises glass fibers of the glass fiber mat 12.

In some embodiments, a thermosetting polymeric binder 13 in aqueous or powder form can be applied between the untreated glass fiber sheet 12 and the porous synthetic top layer 44 by at least one spraying means 15 before the nip at the roller 16 to provide improved layer bonding, as illustrated in FIG. 4. Suitable thermosetting polymeric binders include a polyacrylate, polystyrene, polyester, polyethylene, polypropylene, polybutylene and mixtures thereof. Various curable water-soluble acrylic resins are suitable as well. Such resins include thermocurable acrylo-polyester resins, including acrylo-polyester binders with hydroxyl functional groups. Acrylo-polyester binders can be prepared as aqueous solutions. Suitable aqueous solutions include solutions with 25 to 75% solids. Suitable aqueous solutions further include solutions with 50% solids. One suitable binder includes a thermosetting acrylo-polyester binder which forms an acrylo-polyester network when blended with hydroxyl-functional groups and exposed to heat, available from HB Fuller under the trade name NF4AD™. Other suitable binders include a system with non-formaldehyde, water-soluble modified polyacrylic acid and a polyalcohol crosslinker, available from BASF under the trade name ACRODUR™. Other suitable binders also include a non-formaldehyde, water-soluble, liquid polyalcohol resin binder, available from BASF under the trade name ARCLIN™ 7018. Other thermosetting binders can be used as well, including a phenol-formaldehyde binder available under the trade name RESI-STRAIN/WOODWELD™ from GP, Inc., a urea formaldehyde binder available under the trade name NOVARES™ from GP, Inc., a melamine formaldehyde binder available under the trade name GP™ urea from GP, Inc., formaldehyde-free resins AQUASET™ 100 and AQUASET™ 600 available from DOW Construction Chemicals, Inc., and PLENCO™ phenolic and NOVOLAC™ resins from Plenco, Inc.

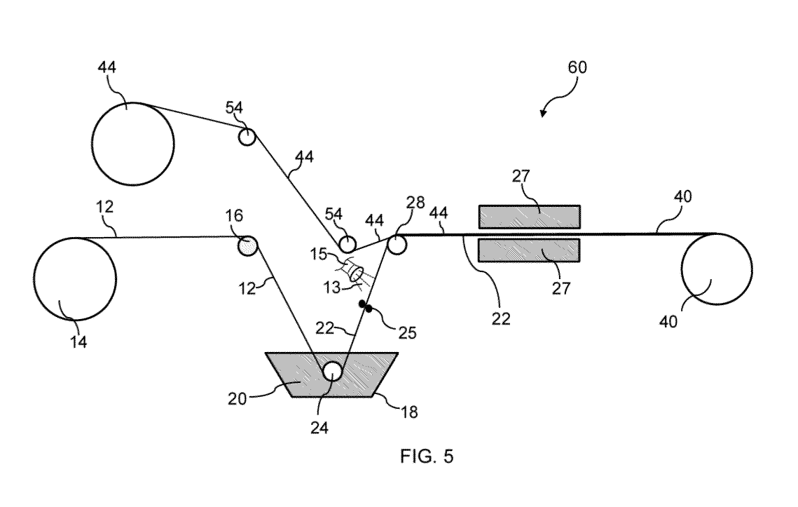

FIG. 5 depicts an alternative embodiment for a method of producing a two-layer glass fiber mat 40. In this method, generally 60, an untreated glass fiber sheet 12 is fed from a reel 14 with a rolling means 16 into a bath 18 filled with a polymeric resin 20 suitable for laminating a glass fiber mat. Various thermoplastic polymers are suitable for laminating a glass fiber mat, including polyacrylate, polystyrene, polyester, polyethylene, polypropylene, polybutylene and mixtures thereof. Various curable water-soluble acrylic resins are suitable for this method. Such resins include thermocurable acrylo-polyester resins, including acrylo-polyester binders with hydroxyl functional groups. Acrylo-polyester binders can be prepared as aqueous solutions. Suitable aqueous solutions include solutions with 25 to 75% solids. Suitable aqueous solutions further include solutions with 50% solids. One suitable binder includes a thermosetting acrylo-polyester binder which forms an acrylo-polyester network when blended with hydroxyl-functional groups and exposed to heat, available from HB Fuller under the trade name NF4AD™. Other suitable binders include a system with non-formaldehyde, water-soluble modified polyacrylic acid and a polyalcohol cross-linker, available from BASF under the trade name ACRODUR™. Other suitable binders also include a non-formaldehyde, water-soluble, liquid polyalcohol resin binder, available from BASF under the trade name ARCLIN™ 7018.

The glass fiber mat 12 is soaked with the polymeric resin 20, and is rolled out from the bath 18 with a rolling means 24. The resin-saturated glass fiber mat 22 is metered with a metering element 25. A porous membrane 44 is fed by rolling means 54 such that the porous membrane 44 comes in contact with the resin-saturated glass fiber mat 22 on the face side of the resin-saturated glass fiber mat 22, and the two-layers 22/44 are fed with a rolling means 28 into a dryer 27 in which the polymeric resin 20 is cured and cross-links glass fibers in the two-layer glass fiber mat 22/44. The polymeric resin 20 also binds and adheres the porous membrane 44 to the glass fiber mat 22. After thermosetting in the dryer 27, the two-layer glass fiber mat 40 can be rolled for storage into a reel. It will be appreciated from this method that the two-layer glass fiber mat 40 is polar with one surface, the face surface, being smooth and porous because it is created by a porous synthetic top layer 44, and the other surface, the back surface, being rough as it comprises glass fibers of the glass fiber mat 12.

In some embodiments, a thermosetting polymeric binder 13 in aqueous or powder form can be applied between the resin-saturated glass fiber sheet 22 and the porous synthetic top layer 44 by at least one spraying means 15 before the nip at the roller 28 to provide improved layer bonding, as illustrated in FIG. 5. Suitable thermosetting polymeric binders include a polyacrylate, polystyrene, polyester, polyethylene, polypropylene, polybutylene and mixtures thereof. Various curable water-soluble acrylic resins are suitable as well. Such resins include thermocurable acrylo-polyester resins, including acrylo-polyester binders with hydroxyl functional groups. Acrylo-polyester binders can be prepared as aqueous solutions. Suitable aqueous solutions include solutions with 25 to 75% solids. Suitable aqueous solutions further include solutions with 50% solids. One suitable binder includes a thermosetting acrylo-polyester binder which forms an acrylo-polyester network when blended with hydroxyl-functional groups and exposed to heat, available from HB Fuller under the trade name NF4AD™, Other suitable binders include a system with non-formaldehyde, water-soluble modified polyacrylic acid and a polyalcohol crosslinker, available from BASF under the trade name ACRODUR™. Other suitable binders also include a non-formaldehyde, water-soluble, liquid polyalcohol resin binder, available from BASF under the trade name ARCLIN™ 7018. Other thermosetting binders can be used as well, including a phenol-formaldehyde binder available under the trade name RESI-STRAIN/WOODWELD™ from GP, Inc a urea-formaldehyde binder available under the trade name NOVARES™ from GP, Inc., a melamine formaldehyde binder available under the trade name GP™ urea from GP, Inc., formaldehyde-free resins AQUASET™ 100 and AQUASET™ 600 available from DOW Construction Chemicals, Inc., and PLENCO™ phenolic and NOVOLAC™ resins from Plenco, Inc.

Further embodiments provide a method for preparing a robust and durable gypsum product made with a two-layer glass fiber mat described above.

In manufacturing of gypsum products, a gypsum slurry comprising calcined gypsum and water is prepared. The gypsum slurry may further comprise organic and/or inorganic fibers, at least one binder, cement, fillers, foam, defoamers, set retarders, set accelerators and plasticizers. Suitable organic and inorganic fibers include, but are not limited to, newspaper, wood chips, fiberglass and the like. Fillers include, but are not limited to, calcium carbonate, mica, clay and talk. Suitable binders include, but are not limited to, starch, acrylic binders and siloxane. Suitable plasticizers include, but are not limited to, naphthalene sulfate and polycarboxylates.

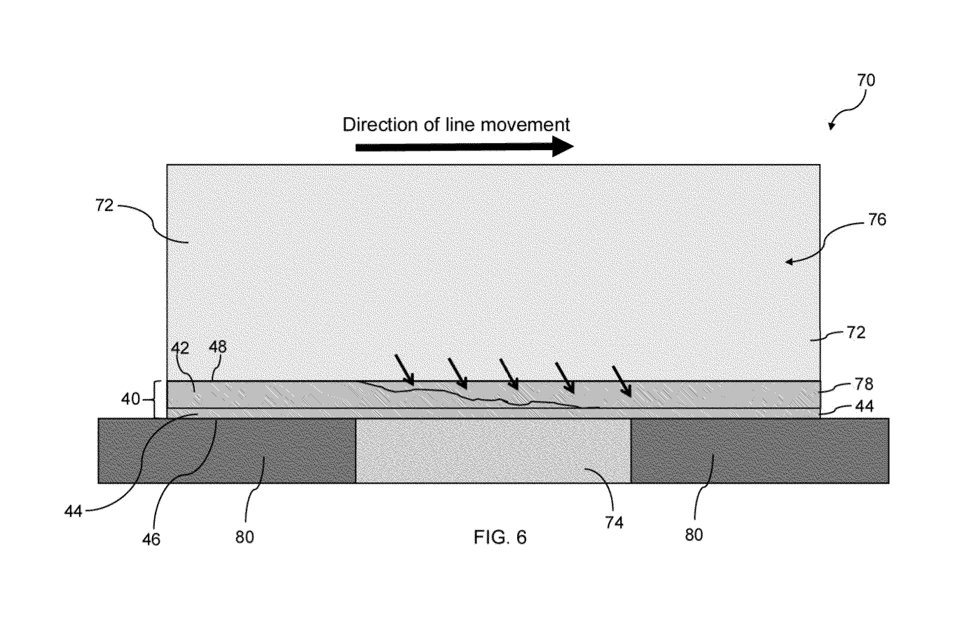

Referring to FIG. 6, it depicts a method, generally 70, for manufacturing a gypsum product, generally 76, with a two-layer glass fiber mat 40 and gypsum slurry 72. In this method, a polar two-layer glass fiber mat 40 is prepared as described above. A gypsum slurry 72 is deposited onto the back surface 48 of the two-layer glass fiber mat 40. Vacuum is applied on the face surface 46 of the two-layer glass fiber mat 40 with at least one means 74. This results in some compression of glass fibers in the glass fiber layer 42 of the two-layer glass fiber mat 40. Some gypsum particles from the gypsum slurry 72 penetrate the glass fiber layer 42 as shown in FIG. 6 in the direction of black arrows. The top-layer 44 has an optimized porosity such that there is no or very little bleed-through of the gypsum slurry 72 from the two-layer glass fiber mat 40.

The porosity value can be measured by the Technidyne porosity tester. This measurement is based upon the time it takes for 100 cc of air to pass through a material after conditioning in a 70° F./50% RH room for 24 hours. The preferred porosity value for the top-layer 44 is between 20 to 80 secs per 100 cc of air.

The vacuum level required in the method 70 depends on the gypsum slurry viscosity, line speed and the fiber glass mat porosity. In general, the vacuum level from 10 to 60 psi is sufficient.

As shown in FIG. 6, the method 70 improves the strength of the gypsum product 76 by promoting penetration of gypsum slurry into a two-layer glass fiber mat 40 by means of vacuum. Further embodiments include methods in which penetration of gypsum slurry 72 into a two-layer glass fiber mat 40 is achieved by vibration of a table 80. A vibration step can be performed before the gypsum product 76 is subjected to vacuum. In alternative, the vibration step can be performed simultaneously with the vacuum treatment or instead of the vacuum treatment.

In further embodiments, penetration of the gypsum slurry 72 can be accomplished with the use of ultrasonic sound instead of or in addition to vibration and/or vacuum. Previous attempts to saturate a glass fiber mat with a gypsum slurry by vibration were not successful in part because of the bleeding through glass fibers in a glass fiber mat. However, the top layer 44 in a two-layer glass fiber mat 40 prevents the bleeding problem and makes the two-layer glass fiber mat 40 suitable for making gypsum products in which glass fibers in the glass fiber mat are saturated with a gypsum slurry by at least one of the following: vibration, vacuum suction and ultrasonic sound.

It will be appreciated that further embodiments include methods in which a gypsum slurry is sandwiched between two two-layer glass fiber mats.

After the gypsum slurry 72 enters the glass fiber mat 42, it crystalizes in the glass fiber mat 42 which produces a glass-fiber mat 78 in which glass fibers are compressed and inter-connected with gypsum crystals. This results in strengthening of the glass fiber matrix. These gypsum products perform better in a nail-pull test as gypsum crystals prevent the pre-matured cutting and collapse of the glass fiber mat matrix as well as provide additional resistance to the load by the nail head in a nail-pull test.

While particular embodiments have been shown and described, it will be appreciated by those skilled in the art that changes and modifications may be made thereto without departing from the invention in its broader aspects and as set forth in the following claims.

What is claimed is:

1. A gypsum product comprising a gypsum core and at least one two-layer polar glass fiber mat, wherein the two-layer polar glass fiber mat covers the gypsum core on at least one side and wherein the two-layer polar glass fiber mat has a face surface and a back surface, the two-layer polar glass fiber mat comprises a glass fiber mat and a top porous layer, the top porous layer is adhered to the glass fiber mat on one side and creates the face surface, and the gypsum core is in contact with the glass fiber mat on the back surface of the two-layer polar glass fiber mat.

2. The product of claim 1, wherein glass fibers in the glass fiber mat are cross-linked with gypsum and compressed.

3. The product of claim 1, wherein glass fibers in the glass fiber mat are cross-linked with a thermosetting polymeric resin selected from the group consisting of a polyacrylate, polystyrene, polyester, polyethylene, polypropylene, polybutylene and mixtures thereof.

4. The gypsum product of claim 1, wherein the gypsum product has a level 5 finish.

5. The gypsum product of claim 1, wherein the top porous layer is selected from the group consisting of a synthetic membrane, polymeric film and synthetic paper.

6. The gypsum product of claim 1, wherein the top porous layer is made from at least one of the following: polytetrafluoroethylene, polypropylene fibers, LDPE (low-density polyethylene) fibers, acrylic fibers, polyester fibers, polyester/nylon fibers, urethane films, plastic films, polyurethane films and plastic netting.

7. The gypsum product of claim 1, wherein the top porous layer is adhered to the glass fiber mat by a thermosetting polymeric resin.

8. The gypsum product of claim 7, wherein the thermosetting polymeric resin is selected from the group consisting of a polyacrylate, polystyrene, polyester, polyethylene, polypropylene, polybutylene, phenol-formaldehyde, urea-formaldehyde, melamine-formaldehyde and any mixture thereof.

9. The gypsum product of claim 1, wherein the porosity of the glass fiber mat is different from the porosity of the top porous layer, and wherein the porosity of the top porous layer is in the range from 20 to 80 sec/100 cc.

10. A method for making a gypsum product, the method comprising:
obtaining a glass fiber mat;
obtaining a porous synthetic material selected from the group consisting of synthetic paper, synthetic film and membrane;
laminating the glass fiber mat with a thermosetting polymeric resin by soaking the glass fiber mat in the thermosetting polymeric resin;
disposing the porous synthetic material on one side of the glass fiber mat and thereby creating a face surface;
curing the thermosetting polymeric resin by exposing it to heat and thereby obtaining a two-layer polar glass fiber mat covered on one side with the porous synthetic material;
preparing a gypsum slurry comprising calcined gypsum and water;
depositing the gypsum slurry onto the back surface of the cured two-layer polar glass fiber mat; and
letting the gypsum product set.

11. The method of claim 10, wherein the step of disposing the porous synthetic material takes place before the glass fiber mat is soaked with a thermosetting polymeric resin.

12. The method of claim 10, wherein the vacuum is applied to the two-layer polar glass fiber mat on the face surface after the gypsum slurry is deposited, but before it sets.

13. The method of claim 10, wherein at least one of the following steps is performed to facilitate penetration of the gypsum slurry into glass fibers of the two-layer glass fiber mat:
vacuum is applied to the face surface of the cured two-layer polar glass fiber mat after the gypsum slurry is deposited onto the back surface of the cured two-layer polar glass fiber mat;
the cured two-layer polar glass fiber mat is caused to vibrate prior to, concurrently with or subsequently after the gypsum slurry is deposited onto the back surface of the cured two-layer glass fiber mat; and
ultrasonic sound is applied to the cured two-layer polar glass fiber mat prior to, concurrently with or subsequently after the gypsum slurry is deposited onto the back surface of the cured two-layer glass fiber mat.

14. A two-layer polar glass fiber mat, comprising a glass fiber mat covered on at least one side with a porous synthetic layer, wherein the porous synthetic layer is adhered to glass fibers of the glass fiber mat.

15. The two-layer polar glass fiber mat of claim 14, wherein the porous synthetic layer is selected from at least one of the following: synthetic membrane, film or synthetic paper.

16. The two-layer polar glass fiber mat of claim 14, wherein glass fibers in the glass fiber mat are cross-linked with a thermosetting polymeric resin selected from the group consisting of a polyacrylate, polystyrene, polyester, polyethylene, polypropylene, polybutylene, and any mixture thereof.

17. The two-layer polar glass fiber mat of claim 14, wherein the porous synthetic layer is made from at least one of the following: polytetrafluoroethylene, polypropylene fibers, LDPE (low-density polyethylene) fibers, acrylic fibers, polyester fibers, polyester/nylon fibers, urethane films, plastic films, polyurethane films and plastic netting.

18. The two-layer polar glass fiber mat of claim 14, wherein the porous synthetic layer is adhered to the glass fiber mat with a thermosetting polymeric resin selected from the group consisting of a polyacrylate, polystyrene, polyester, polyethylene, polypropylene, polybutylene, phenol-formaldehyde, urea-formaldehyde, melamine-formaldehyde and any mixture thereof.

19. The two-layer polar glass fiber mat of claim 14, wherein the porous synthetic layer is hydrophilic.

20. The two-layer polar glass fiber mat of claim 14, wherein the porosity of the glass fiber mat is different from the porosity of the porous synthetic layer, and wherein the porosity of the porous synthetic layer is in the range from 20 to 80 sec/100 cc.
